(19) United States
(12) Patent Application Publication
(10) Pub. No.: US 2023/0025905 A1
(43) Pub. Date: Jan. 26, 2023

(54) Detachable Storage Assembly

(71) Applicant: Sunny Firpo, Clovis, CA (US)

(72) Inventor: Sunny Firpo, Clovis, CA (US)

(21) Appl. No.: 17/380,741

(22) Filed: Jul. 20, 2021

(51) Int. Cl. B62B 3/14

(52) U.S. Cl. CPC B62B 3/1464

(57) ABSTRACT

A detachable storage assembly for increasing a storage capacity of a shopping cart includes a shelving unit, which is mountable to a front of a basket of a shopping cart. The shelving unit extends outwardly from the basket and a bottom shelf of the shelving unit is substantially coplanar with and positioned proximate to a lower frame element of the shopping cart to which wheels of the shopping cart are attached. The shelving unit permits stowage of an article, such as a large package of toilet paper, paper towels, and the like, which normally would occupy a large portion of the basket.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage assemblies and more particularly pertains to a new storage assembly for increasing a storage capacity of a shopping cart. The present invention discloses a storage assembly comprising a shelf, which is selectively attachable to a front of a shopping cart so that the shelf is positioned proximate to a wheelbase of the shopping cart and extends outwardly from the basket.

### (2) Description of Related Art Including Information Disclosed Under 37 CFR 1.97 and 1.98

The prior art relates to storage assemblies. Prior art storage assemblies may comprise various baskets and shelves, which are engageable to shopping carts so that they are positioned within the shopping carts. Prior art storage assemblies also may comprise shopping carts with shelves that extendible from their back ends. What is lacking is storage assembly comprising a shelf that is selectively attachable to a front of a shopping cart, a position in which it does not impinge upon a user of the shopping cart. The shelf is positioned proximate to a wheelbase of the shopping cart and extends outwardly from the basket, allowing for oversized articles to be positioned upon it rather than in the basket.

### BRIEF SUMMARY OF THE INVENTION

An embodiment of the disclosure meets the needs presented above by generally comprising a shelving unit, which is configured to be mountable to a front of a basket of a shopping cart. The shelving unit extends outwardly from the basket and a bottom shelf of the shelving unit is substantially coplanar with and positioned proximate to a lower frame element of the shopping cart to which wheels of the shopping cart are attached. The shelving unit is configured for stowage of an article, such as a large package of toilet paper, paper towels, and the like, which normally would occupy a large portion of the basket.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a detachable storage assembly according to an embodiment of the disclosure.

FIG. 2 is a side view of an embodiment of the disclosure in a deployed configuration.

FIG. 3 is a side view of an embodiment of the disclosure in a stowed configuration.

FIG. 4 is a front view of an embodiment of the disclosure in a deployed configuration.

FIG. 5 is a front view of an embodiment of the disclosure in a stowed configuration.

FIG. 6 is a rear view of an embodiment of the disclosure.

FIG. 7 is an in-use view of an embodiment of the disclosure.

### DETAILED DESCRIPTION OF THE INVENTION

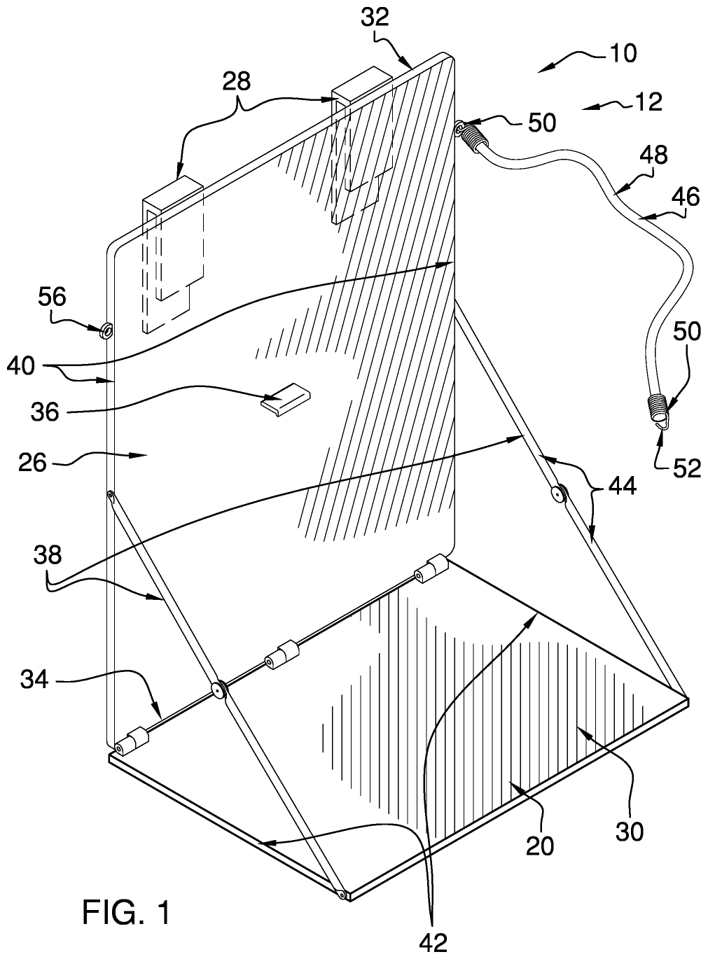

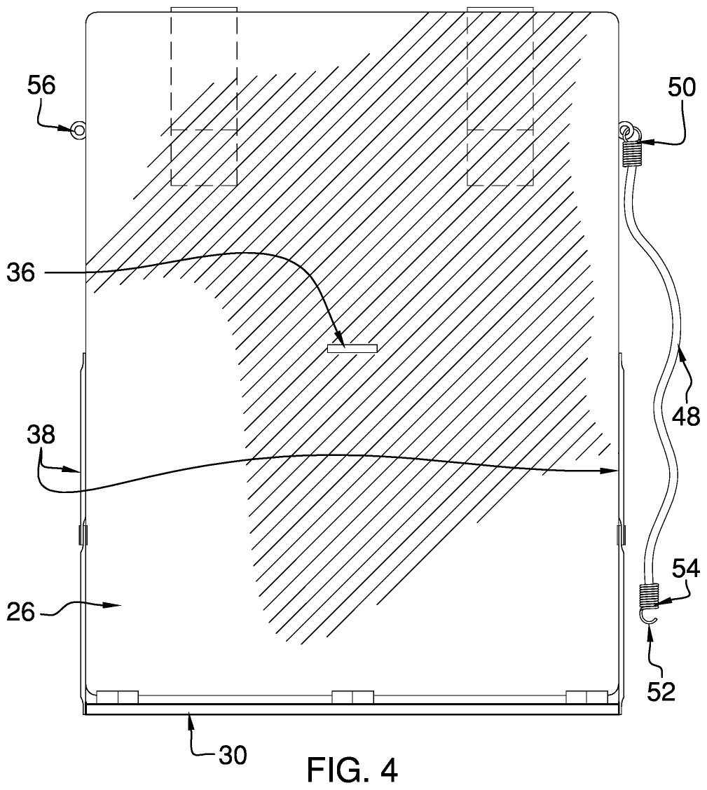

With reference now to the drawings, and in particular to FIGS. 1 through 7 thereof, a new storage assembly embodying the principles and concepts of an embodiment of the disclosure and generally designated by the reference numeral 10 will be described.

As best illustrated in FIGS. 1 through 7, the detachable storage assembly 10 generally comprises a shelving unit 12, which is configured to be mountable to a front 14 of a basket 16 of a shopping cart 18. The shelving unit 12 extends outwardly from the basket 16 and a bottom shelf 20 of the shelving unit 12 is substantially coplanar with and positioned proximate to a lower frame element 22 of the shopping cart 18 to which wheels 24 of the shopping cart 18 are attached. The shelving unit 12 is configured for stowage of an article, such as a large package of toilet paper, paper towels, and the like, which normally would occupy a large portion of the basket 16. The shelving unit 12 also may benefit store owners, as not having large packages occupying the basket 16 allows for shoppers to add other items to the basket 16.

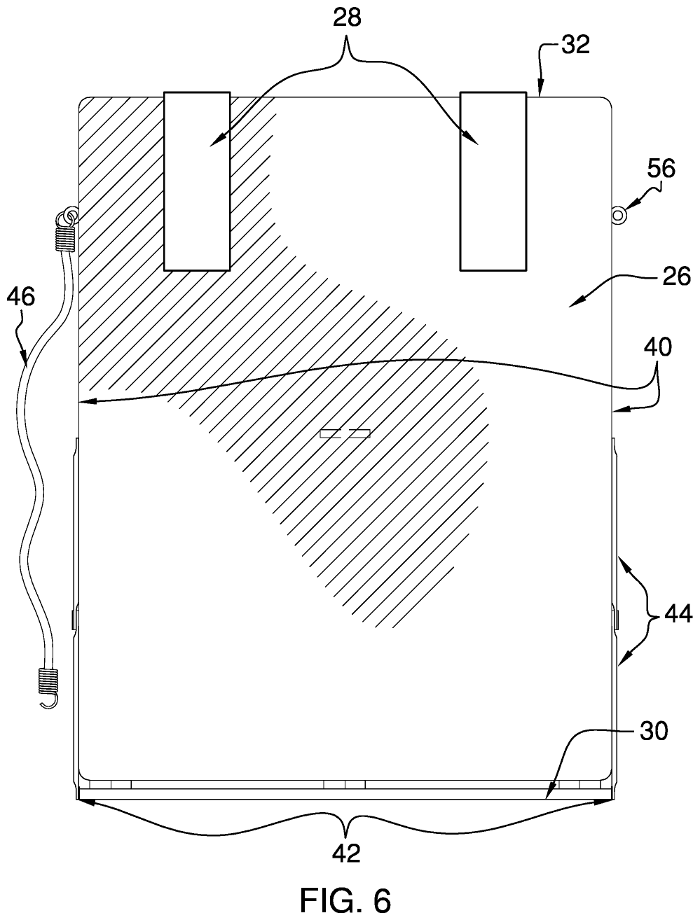

The shelving unit 12 comprises a first plate 26, a set of brackets 28 and a second plate 30. The brackets 28 are engaged to and extend from an upper end 32 of the first plate 26 and are configured to selectively engage the front 14 of the shopping cart 18 so that the first plate 26 is removably engaged to the shopping cart 18. The first plate 26 extends along the front 14 of the shopping cart 18 to proximate to the lower frame element 22. The set of brackets 28 may comprise two brackets 28, as shown in FIG. 6, or other number of brackets 28, such as one bracket 28 or three or more brackets 28.

The second plate 30 is engaged to and extends substantially perpendicularly from a lower end 34 of the first plate 26. The second plate 30 is substantially coplanar with and positioned proximate to the lower frame element 22 of the shopping cart 18. The second plate 30 comprises the bottom shelf 20 and is configured to position of the article. The present invention also anticipates the shelving unit 12 comprising additional shelves (not shown).

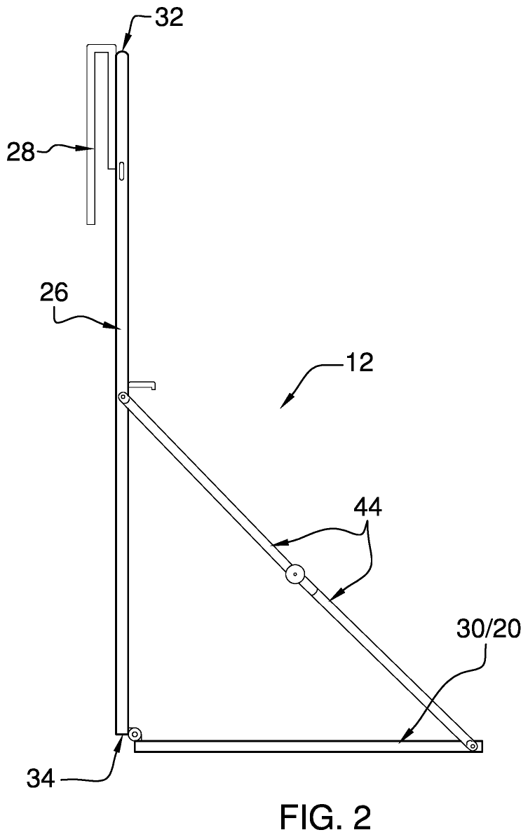

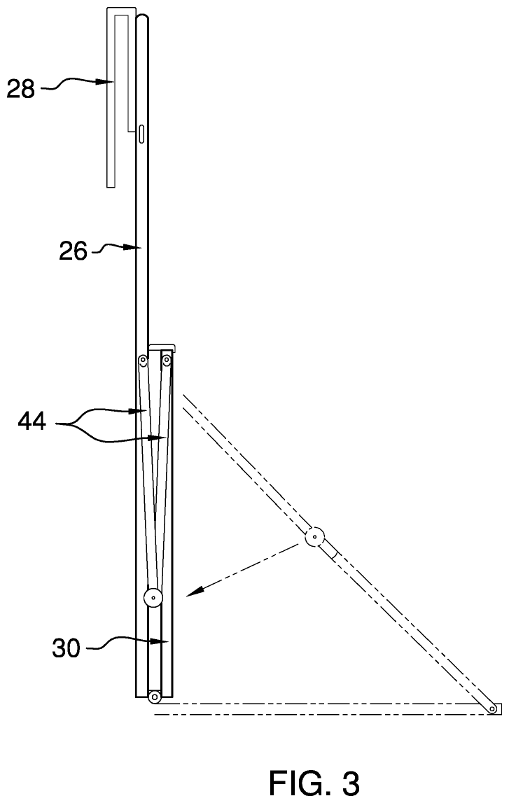

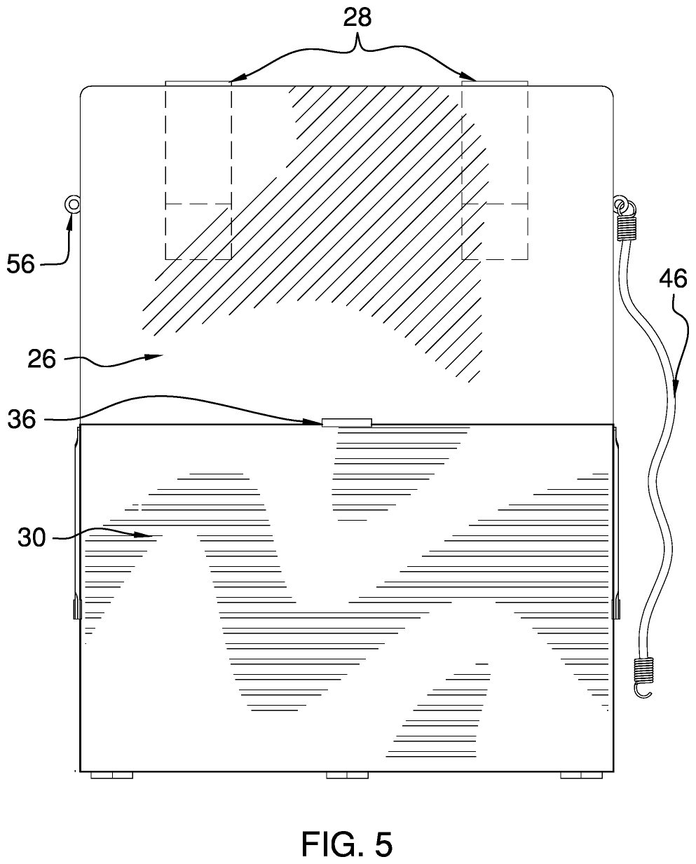

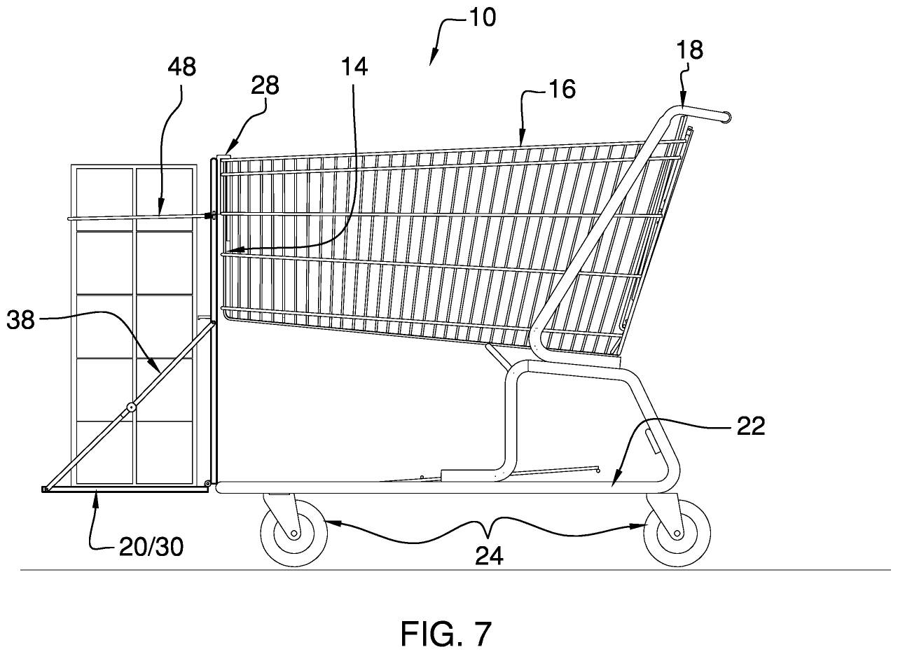

The second plate 30 is hingedly engaged to the first plate 26 and thus is selectively positionable in a deployed configuration and a stowed configuration. In the deployed configuration, as shown in FIGS. 2 and 7, the second plate 30 extends substantially perpendicularly from the first plate 26. In the stowed configuration, as shown in FIGS. 3 and 5, the second plate 30 is substantially parallel to and in abutment with the first plate 26. A latch 36 is engaged to the first plate 26 and is positioned to selectively engage the second plate 30 to retain the second plate 30 in the stowed configuration.

Each of a pair of side arms 38 is hingedly engaged to and extends between a respective opposed side 40 of the first plate 26 and an associated opposed edge 42 of the second plate 30. The side arm 38 comprises a pair of sections 44, the sections 44 of which are mutually hingedly engaged. The side arm 38 thus extends substantially linearly between the first plate 26 and the second plate 30 with the second plate 30 in the deployed configuration. The side arm 38 is positioned to fold as the second plate 30 is motivated to the stowed configuration.

A fastener 46 is engaged to the first plate 26 and is configured to selectively engage the article positioned on the first plate 26 so that the article is removably engaged to the shopping cart 18. The fastener 46 may comprise a bungee cord 48, as shown in FIG. 6, a rope, a strap, or the like. The bungee cord 48 has a first end 50, which is engaged to one opposed side 40 of the first plate 26. A hook 52 is engaged to a second end 54 of the bungee cord 48. A ring 56 is engaged to the other opposed side 40 of the first plate 26. The bungee cord 48 is configured to be stretched around the article positioned on the second plate 30, positioning the hook 52 to engage the ring 56 so that the article is removably engaged to the shopping cart 18.

In use, the brackets 28 are used to attach the shelving unit 12 to the front 14 of the basket 16. As needed, the second plate 30 can be hinged to the deployed configuration and an article can positioned upon it. The article can be secured with the bungee cord 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A detachable storage assembly comprising:
a first plate;
a set of brackets engaged to and extending from an upper end of the first plate and being configured for selectively engaging a front of a shopping cart such that the first plate is removably engaged to the shopping cart and such that the first plate extends along a front of the shopping cart to proximate a lower frame element of the shopping cart coupled to a plurality of wheels of the shopping cart; and
a second plate engaged to and extending substantially perpendicularly from a lower end of the first plate and forwardly of the front of the shopping cart such that the second plate is substantially coplanar with and positioned proximate to the lower frame shopping cart, the second plate having a proximal end and a distal end relative to the first plate, the second plate having a pair of opposed sides extending between the proximal end and the distal end, said distal end being free, said pair of opposed sides being partially free, wherein the second plate is configured for positioning of an article thereon.

2. (canceled)

3. The detachable storage assembly of claim 1, wherein the set of brackets comprises two brackets.

4. The detachable storage assembly of claim 1, wherein the second plate is hingedly engaged to the first plate, such that the second plate is selectively positionable in a deployed configuration, wherein the second plate extends substantially perpendicularly from the first plate, and a stowed configuration, wherein the second plate is substantially parallel to and in abutment with the first plate.

5. The detachable storage assembly of claim 4, further including a pair of side arms, each side arm being hingedly engaged to and extending between a respective opposed side of the first plate and an associated opposed edge of the second plate, the side arm comprising a pair of sections, the sections being mutually hingedly engaged, such that the side arm extends substantially linearly between the first plate and the second plate with the second plate in the deployed configuration, and such that the side arm is positioned for folding as the second plate is motivated to the stowed configuration.

6. The detachable storage assembly of claim 4, further including a latch engaged to the first plate and being positioned for selectively engaging the second plate for retaining the second plate in the stowed configuration.

7. The detachable storage assembly of claim 1, further including a fastener engaged to the first plate and being configured for selectively engaging the article positioned on the second plate, such that the article is removably engaged to the shopping cart.

8. The detachable storage assembly of claim 7, wherein the fastener comprises:
a bungee cord, the bungee cord having a first end engaged to one opposed side of the first plate;
a hook engaged to a second end of the bungee cord; and
a ring engaged to the other opposed side of the first plate, wherein the bungee cord is configured for stretching around the article positioned on the second plate, positioning the hook for engaging the ring, such that the article is removably engaged to the shopping cart.

9. (canceled)

10. A detachable storage assembly comprising:
a first plate;
a set of brackets engaged to and extending from an upper end of the first plate and being configured for selectively engaging the front of a shopping cart such that the first plate is removably engaged to the shopping cart and such that the first plate extends along a front of the shopping cart to proximate to a lower frame element of the shopping cart coupled to a plurality of wheels of the shopping cart, the set of brackets comprising two brackets;
a second plate engaged to and extending substantially perpendicularly from a lower end of the first plate and forwardly of the front of the shopping cart such that the second plate is substantially coplanar with and positioned proximate to the lower frame element of the shopping cart, the second plate having a proximal end and a distal end relative to the first plate, the second plate having a pair of opposed sides extending between the proximal end and the distal end, said distal end being free, said pair of opposed sides being partially free, wherein the second plate is configured for positioning of an article thereon, the second plate being hingedly engaged to the first plate, such that the second plate is selectively positionable in a deployed configuration, wherein the second plate extends substantially perpendicularly from the first plate, and a stowed configuration, wherein the second plate is substantially parallel to and in abutment with the first plate, and
a pair of side arms, each side arm being hingedly engaged to and extending between a respective opposed side of the first plate and an associated opposed edge of the second plate, the side arm comprising a pair of sections, the sections being mutually hingedly engaged, such that the side arm extends substantially linearly between the first plate and the second plate with the second plate in the deployed configuration, and such that the side arm is positioned for folding as the second plate is motivated to the stowed configuration;
a latch engaged to the first plate and being positioned for selectively engaging the second plate for retaining the second plate in the stowed configuration;
a fastener engaged to the first plate and being configured for selectively engaging the article positioned on the second plate, such that the article is removably engaged to the shopping cart, the fastener comprising:
a bungee cord, the bungee cord having a first end engaged to one opposed side of the first plate; and
a hook engaged to a second end of the bungee cord; and
a ring engaged to the other opposed side of the first plate, wherein the bungee cord is configured for stretching around the article positioned on the second plate, positioning the hook for engaging the ring, such that the article is removably engaged to the shopping cart.
